(19) United States
(12) Patent Application Publication
(10) Pub. No.: US 2020/0002040 A1
(43) Pub. Date: Jan. 2, 2020

(54) Packaging Machine and Method for Operating a Packaging Machine

(71) Applicant: SIG Technology AG, Neuhausen am Rheinfall (CH)

(72) Inventors: Bernd von Birgelen, Waldfeucht (DE); Bernd Lünnemann, Duesseldorf (DE); Markus Klaus, Eschweiler (DE); Klaus Naber, Kempen (DE); Frank Ott, Neuss (DE); Stefan Reiners, Heinsberg (DE); Michael Schaaf, Herzogenrath (DE); Marcel Schopen, Leverkusen (DE); Michael Stoll, Hueckelhoven (DE); Franco Zagar, Grefrath (DE); Taoufik Mbarek, Wuerselen (DE)

(21) Appl. No.: 16/485,562

(22) PCT Filed: Feb. 6, 2018
(86) PCT No.: PCT/EP2018/052913

§ 371 Date: Aug. 13, 2019

(30) Foreign Application Priority Data
Feb. 14, 2017 (DE) 10 2017 102 914.1

(51) Int. Cl. B65B 43/54; B65B 3/02; B65B 3/04; B65B 7/18; B65G 54/02; B65G 23/23; B65B 43/10

(52) U.S. Cl. CPC B65B 43/54; B65B 3/025; B65B 3/04; B65G 2201/0244; B65G 54/02; B65G 23/23; B65B 43/10; B65B 7/18

(57) ABSTRACT

Packaging machine, in particular filling device, having at least one transport rail, and at least two transport slides movable along the transport rail and arranged on the transport rail, the transport slides being arranged for transporting at least one package and being moved clocked along a productive region of the transport rail. A processing becomes more flexible if the transport rail and the transport slides are so electromotively connected that the transport slides are moved along a productive area with two indices different from each other.

The subject matter concerns a packaging machine and a method of operating a packaging machine.

In particular, the subject matter concerns both a device and a method for filling beverage containers, in particular composite packaging. In a productive area (also referred to as a process unit) of a packaging machine, the packages are processed and, in particular, filled at a filling station to which the packager are fed. The filled, still open packages are then removed from the filling station and sealed into finished packages.

Such processes and also the devices used for them, often also referred to as filling devices, have long been known in practice in many different designs. Well-known packaging machines work in cycles, whereby the packages are fed at a certain rate in one cycle and remain at the processing station for a certain dwell time. The cyclical transport of packages, especially on transport chains of upright and open top packages, has only relatively short dwell times in order to achieve a high throughput. This means that the product to be filled must be placed in the packages in a relatively short time, namely during the dwell time. Despite the use of large filling cross-sections, this leads to strong foam formation depending on the product and to sloshing of the product during the jerky further transport of the packages. This is undesirable, as it may cause the edges of the packages to be sealed immediately after filling to be wetted with the product, thereby impairing the sealing quality. This can also lead to filling quantity fluctuations.

A proposal to increase the dwell time is known from DE 10 356 073 B4. In this example, the packages are moved by two independent transport devices, namely the transport chain and the secondary chain. The secondary chain allows the packages to be moved with a larger index than is the case with the transport chain. However, the cycle of the packaging machine is determined by the transport chain and the packs are transferred to the secondary chain and, after filling, are transferred back from the secondary chain to the transport chain.

This is complex and mechanically demanding. In particular, two independent chains have to be operated, which increases the maintenance effort enormously. Furthermore, the transfer points between the independent chains are mechanically error prone.

The objective was therefore to improve a cycled packaging machine for the packaging and/or filling of products in particular in packages open at their top.

This object is solved by a packaging machine according to claim 1 and a method according to claim 29.

First, it should be noted that the features of each dependent claim may be independently inventive and be disclosed even without the distinctive feature of the independent claims in conjunction with one or more features of the generic concept of independent claims and/or other features described here or mentioned in the claims. In particular, any combination of the features mentioned in the claims as well as in the description is according to the subject matter disclosed without any of the features being emphasized.

Cardboard/plastic composite packages that are used for various flowable or pourable products are known from practical experience. The main field of application for such carton/plastic composite packages is the packaging of beverages and pasteurised foodstuffs. The well-known packs and packages are available in different shapes. These are typically rectangular, cubic and cylindrical. The biggest differences still exist with regard to the package head, which is predominantly designed as a so-called flat gable or slanted gable.

Packages can be produced in different ways and from different materials. A widely used way of manufacturing them is to make a blank from the packaging material, from which, by folding and other steps, a pack sleeve is first produced and one end of which can be sealed. The pack can then be filled through the other longitudinal end of the sleeve, which is still at least partially open. In some of these processes, a pack blank is formed onto a mandrel of a mandrel wheel.

One of the advantages of this production method is that the blanks and pack sleeves are very flat and can therefore be stacked to save space. In this way, the blanks or sleeves can be produced at a location different from that at which the sleeves are folded and filled. Composites are often used as a material, for example a composite of several thin layers of paper, cardboard, plastic or metal, especially aluminum. Such packages are widely used in the food industry in particular.

It should be noted that, where packaging, packaging sleeves, packs or pack sleeves are referred to below, those terms may be used interchangeably and, as a general rule, may also be formed within the meaning of the above description.

The subject matter provides a turn away from conventional transport chains or conveyor belts. The packages are moved by means of transport slides. The transport slides are arranged movably along at least one transport rail. The transport rail and the transport slides together form an electromotive drive, especially in the form of a linear motor.

The transport rail defines the transport trajectory of the transport slides. Each individual transport slide can be controlled independently and individually on the transport rail. Due to the electromotive active connection between the transport rail and the transport slides, each individual transport slide can always be individually controlled and moved at an adjustable speed, with an adjustable acceleration profile, an adjustable stroke and/or to an adjustable position on the transport rail. Start and stop times for the movement of the individual transport slides can also be set individually.

The packaging machine according to the subject matter is cycled at least section by section. In particular, this can mean that a cycle is formed from a feed time and a dwell time. During the feed time, the transport slide is moved between two workstations of the packaging machine. During the dwell time, the transport slide is stationary in the direction of movement specified by the transport rail and the packaging arranged on the transport slide can be further processed, in particular sterilized, filled, sealed and/or processed.

Along a productive area (also known as a process area), a number of workstations of the packaging machine can be arranged. With each cycle, the transport slides/packages can be moved to a downstream workstation, in particular to the immediately next workstation or the workstation after that, where they can be processed further. After the feed and the dwell time, one cycle can be over and the next cycle can start.

A carrier on which at least one package, but preferably two or more packages, can be carried simultaneously may preferably be arranged on a transport slide. The carrier can be mechanically designed in such a way that it can accommodate the base of a package. The carrier can also be designed mechanically in such a way that it can take up a package clamped, preferably laterally clamped. In particular, the carrier can be relatively easily removed from the transport slide and replaced by another carrier. Thus, the transport slide can serve as a guiding medium for different types of carriers and different types of packages with different cross-sections or shapes can be used on different carriers.

It is also proposed that a carrier can accommodate different packages in such a way that, irrespective of the linear expansion of the packages for different packages, the top edge of the packages at least one point on the transport rail has the same level, in particular the same distance from the transport rail. Here, the carrier can either pick up the packages at different positions in the longitudinal direction or the carrier can adjust the relative position of the packages to the transport rail, in particular transversely or at right angles to the transport rail. This can ensure that the top edge of a package, irrespective of the longitudinal expansion of the package, is equally spaced from the transport rail at least one point along the transport rail. This is particularly useful for packages with different filling volumes, as the same distance between an opening and a filling device, for example, can always be maintained and the packages can be moved at the same distance along the filling device and filled there.

As already explained, the transport slides are moved along a productive area at least in cycles. In one cycle, the transport slide is moved during a feed time and during a dwell time, the slide remains stationary at a workstation in the defined direction of movement. The slide can also pass through a workstation. It has been recognised that the relationship between hold time and feed time can be varied due to the electromotive connection between the transport rail and the transport slide and the resulting individualised controllability of each individual transport slide along the productive area. This is particularly interesting for the reason that the dwell time should be as long as possible, especially when filling liquid products into the packages, in order to prevent the filling quantity, the filling quality and/or foam formation and, if necessary, sloshing. The feed time should preferably be designed in such a way that sloshing is reduced. This can be achieved in particular by means of an acceleration profile during the feed.

It is therefore proposed that the transport slides are moved along the productive area with at least two different indexes. For example, a first index formed by dwell and feed time can be approximately one. This means that in a cycle consisting of dwell time and feed time, the dwell time is approximately equal to the feed time. However, along the productive area, it is possible that the relationship between dwell time and feed time is variable with the same cycling, and the index is therefore variable. This is not possible with conventional chain drives, as the packaging is always guided on the same chain, which represents the same index for all packaging.

The use of two different chains, as known from DE 10 356 073 B4, is mechanically complex. In a particularly simple mechanical way, the transport rail and transport slide enable the realization of different indices along the productive area.

The index can be varied along the productive area using the transport slide and the transport rail. In order to vary the index, it is also possible for a package or a transport slide to be advanced with each individual cycle and to have a dwell time in the case of a first index. A different index can be realized by the fact that the feed and dwell time, in particular comprise several cycles, for example two cycles. This means that during a first cycle at least the feed and possibly a partial dwell time is realized at a single workstation and no new feed takes place at a second cycle, but only a dwell time is realized at the workstation previously approached.

This means that a first workstation (which is approached in a simple index, for example) must process the packaging further in exactly one cycle, a second workstation (which is approached in an N-fold index (N=2, 3, 4, . . . ), for example) can do this in N cycles.

In order to design the filling of packages moved in cycles in such a way that the filling quality of the filling can be improved, e.g. in order to achieve exactly reproducible filling quantities, it is also proposed that the transport slides are moved in the productive area in the area of a filling device, in particular a bottling device, with a different, in particular larger index than outside the filling device. For example, it is possible to move the packages outside the filling device with a simple index. In this case, for example, the transport slide is advanced once per cycle and remains at the workstation for a dwell time. A larger index, for example an N-fold index, can be implemented within the filling device. In this case, the package is advanced only once within N cycles and remains a longer dwell time at the workstation.

Due to the longer dwell time, which is realized by the higher index, the filling time is increased. This makes it possible to bring the product to be filled into the packages with a lower volume flow. This increases the filling quality.

If a larger index is implemented, in particular an N-fold index, it may be necessary to increase the number of identical workstations accordingly. This means that if the packages are moved by the transport slides in the filling device with an N-fold index, the number of filling stations should be increased accordingly. In particular, this can be useful in order to be able to transfer packages into the productive area and out of the productive area with a same cycle. If, for example, a double index is required for packages, it should preferably be possible to fill two packages at the same time so that two packages can also be filled after two cycles have elapsed. This corresponds to the filling rate with a filling device with a simple index. Each individual package would be filled within only one cycle, thus two packages after two cycles.

With a double index, for example, the time a package spends at the filling device can be two cycles, so that two packages must also be processed in one filling device during this time. The output at the end of the filling device then corresponds exactly to the same number of packages that were fed into the filling device.

As already explained, the index can be determined by the hold time at a workstation and a feed time between two workstations. The index can also be determined by the number of cycles a workstation should have available to process the packages. In particular, it may make sense to use at least two cycles on the filling device, in particular the bottling device. In this case, the hold time at the filling device, in particular the bottling device as a workstation, may be longer than the feed time.

The index may also be a non-integer multiple of 1, in particular 1.5 or 0.5.

The increased index allows the feed stroke to be increased compared to a lower index, especially in one cycle with the same feed time. A higher speed of the transport slide is required for the larger stroke. In the same feed time, the transport slides are thus transported over a longer transport distance. This increases the clearance between transport slides moved with a single index and transport slides moved with an increased index.

Due to the larger transport stroke initially carried out at a larger index, e.g. in the unfilled state, there is more time available for the actual filling process of the package until the new empty packages are fed to the package currently being filled. Slower filling when the package is stationary can significantly reduce foam formation without having to delay the rate of the packaging machine.

The product to be filled into the package can be a liquid, but also pasty products with or without chunky parts. The products can also be bulk or powdery.

By increasing the index, it is advantageous for the filling device to be able to fill at least two packages arranged one behind the other in the transport direction at the same time in order to achieve the same cycle rate over the entire productive area. This is advantageous, as several neighbouring packages can preferably be advanced simultaneously with an increased index in the transport direction and are available for a multiple of the cycle time for the filling process. It has been recognized that by increasing the index, in particular by varying the dwell time to the feed time, the actual filling process can also be independent of the other cycle of the transport slide.

According to an embodiment, it is proposed that at least N transport slides with an N-fold index are moved in the filling device, where N is at least two. It has been recognized that a number of transport slides with this index should be increased according to the increase of the index in the area of the filling device. This has the advantage that the overall rate along the productive area can remain the same. In this case, it is advantageous if N filling devices are provided in the corresponding filling area as well as when N packages can be filled simultaneously in the filling area.

The increase in the index is accompanied in particular by an increase in the feed speed and/or the transport stroke. For this reason, it is proposed that at least two transport slides with a different, preferably increased, in particular at least double feed speed are moved in the filling device. In particular, the different, preferably increased, in particular preferably double feed rate is realized in the area in which the increased index is realized.

It is also proposed that at least two transport slides with a different, preferably increased, preferably at least double transport stroke are moved in the feed time. This means that the transport stroke for the larger index is increased compared to the transport stroke for a simple index.

According to an embodiment, it is proposed that the feed time between two workstations is constant in the productive area. In particular, the feed time is constant at the transition from the lower index to the higher index. This means that the feed time for feeding the transport slide to the last workstation with the first index is the same as the feed time of the transport slide from this workstation to the next workstation, where in the latter case the index is already increased, in particular doubled. With the same feed time, however, the transport stroke is preferably increased, in particular doubled.

In the area of the higher index, the transport speed is usually higher than in the area of the lower index. Due to the increased transport speed, preferably with a constant transport stroke, the dwell time at the workstation can be increased. This increased dwell time can be used to fill the packaging with the goods to be packaged. If the index is increased, in particular at least doubled, a package in the area of the higher index is preferably moved at an increased speed. In particular, this enables an increased transport stroke with the same transport time. Due to the higher speed, the dwell time at a filling device is increased.

It is also proposed that the dwell time (hold time) of at least two transport slides on at least one of the filling devices be greater than or less than in particular the dwell time of the transport slides outside the filling device, in particular at least twice the hold time of the packages outside the filling device. In this context, it should be noted that the terms ‘hold time’ and ‘dwell time’ can be used equivalently.

As already explained, a cycle is determined in particular by a feed time and a dwell time. In the area of the higher index, a higher transport stroke is preferably realized in the feed time. For this reason, it is proposed that the transport stroke of the transport slides in the productive area is different between two workstations in one cycle. This means that between two first workstations, especially with a lower index, a first transport stroke is realized and between two workstations, if a higher index is realized, the transport stroke is increased. In a first cycle, for example, a package can cover a first transport stroke and in a subsequent cycle, this package can cover a second transport stroke, which is preferably larger, in particular at least twice the first transport stroke. If the feed time is the same, the speed in this second cycle can be twice the speed of the first cycle.

Due to the individual controllability of the individual transport slides, it is possible to realize different acceleration profiles during the feed time. The various acceleration profiles can be adapted to the condition of the packages. For example, it is possible to accelerate a filled package with a less steep acceleration profile than an unfilled package. The acceleration profile can also be adapted to the contents of the package, for example depending on the viscosity of the product filled into the package.

The transport rail is preferably divided into different areas. The transport rail can extend from an infeed area via a productive area to an outfeed area and, if necessary, a buffer area. Workstations can be located in the infeed area, in the productive area or in the outfeed area. Particularly in the productive area, various workstations can be provided, including in particular a filling station or a filling device. The transport slides can be moved along the productive area in the transport direction of the packages with different indexes. Here it is possible that the transport slides at some workstations dwell only during one cycle, at other workstations dwell at least during two cycles. The dwell time is the time remaining after the feed time within a cycle or within several cycles. The dwell time at each station can also be different as long as the package is moved to the next station at the end of the cycle so that the following package can be processed at the station. This can be particularly useful for the filling device of the following stations, since the feed time can be increased with a shorter dwell time, which leads to a reduction in acceleration and thus counteracts staggering.

It is also proposed that the transport direction or the direction of movement of the transport slides should be at an angle to one another in regions, in particular vertically in at least one region and horizontally in at least one region. Angular can include an angle between 30° and 60°. Thus, the transport slides are moved at an angle to each other along a trajectory formed by the transport rail. The directions of movement are preferably vertical and horizontal.

As already explained, the transport slide and transport rail are electromotively connected to each other. In particular, the transport slides are driven electromagnetically. Here, the transport rail and transport slide can form a linear motor. The advantage of the linear motor is that each individual transport slide can be controlled individually. For this purpose, each individual transport slide preferably has an electromagnetically readable identifier. In addition, the transport rail has reading means to be able to read out the position of each transport slide and the identification of the transport slide. This means that each individual transport slide can be individually controlled by means of a suitable control of the transport rail.

A transport slide may have a carrier which is formed to accommodate packages which are preferably opened upwards and preferably already closed at the bottom. Preferably several packages can be picked up next to each other on or through such a carrier, transverse to the direction of movement of the packages. This enables parallel processing of packages arranged next to each other, transverse to the transport direction, so that the throughput of the packaging machine can be increased according to the number of packages arranged next to each other.

According to an embodiment, it is proposed that the transport rail is formed by a stator of the linear motor and in particular has a plurality of solenoids arranged along the transport rail. The magnetic field can be varied along the transport rail and preferably shifted in the direction of movement by suitable activation or excitation of the solenoid coils. The transport slides can thus follow the shifting magnetic field. Preferably, the number of individually controllable magnetic fields is at least equal to the number of transport slides on the transport rail. This means that each individual transport slide can be controlled individually. However, this requires a minimum distance between the transport means, so that the magnetic fields induced by the transport rail do not influence each other in such a way that the transport slide moved by one magnetic field is moved by the other magnetic field.

The transport slides follow the magnetic field of the transport rail, especially if they are formed as permanent magnets. The advantage of designing the transport slides with a permanent magnet is that it is not necessary to electrically excite the transport slides or the solenoid coils arranged in them, which necessitated electrical contact between the transport slides and a contact rail.

Preferably, the transport rail is part of a transport device, through which the transport slides are preferably moved in rotation. The transport rail preferably forms one leg of the transport device. The transport device may have at least three legs at an angle to each other. The transport device preferably forms a closed ring with in particular at least three legs, at least one of which is a transport rail.

According to an embodiment, it is proposed that the transport device has at least two opposite legs, a first of the legs forming the productive area being at least partially guided in the filling device of the packaging machine and a second of the legs forming a buffer area. The buffer area and the productive area are thus located on opposite sides of the transport rail. Either an infeed area or an outfeed area can be provided between the buffer area and the production area. At least one of the opposite legs can be formed as a transport rail.

Unfolded package sleeves, in particular with a closed bottom, are guided to the respective transport slide or its carrier in the infeed area. In the infeed area, the packages are picked up by the carrier and transported to the productive area. In the productive area, the transport slides are moved in a cycled (clocked) fashion whereby in the productive area, at least two different indexes of the transport movement of the transport slides are realized. After the productive area, the filled, preferably closed packages are led to the outfeed area through the transport slides and there feed out from the transport rail.

When moving along the transport rail, it is possible that the transport slides or the carriers of the transport slides guide the packages upright in the productive area. The packages are preferably held by the carriers or the transport slides in such a way that they can also be held at an angle to the horizontal in the infeed area and/or outfeed area. The packages are moved in the infeed area, in the productive area and preferably in the outfeed area along a linear feed direction. However, the transport rail can run at an angle such that, for example, in an outfeed area and/or an infeed area, the transport rail runs at least partially vertically and in the productive area at least partially horizontally. The areas can be at an angle to each other.

The carriers for the packaging can be attached to the transport slide. The carriers can be arranged on the transport slide, especially via magnetic connections or click connections, so that they are easily exchangeable. It is also possible for two transport slides to be movable relative to each other in such a way that they grip the packaging. An edge of a first transport slide or a first carrier pointing to the rear (direction of movement) can interact with an edge of a subsequent transport slide or carrier pointing to the front (direction of movement) in such a way that the package is clamped between the rear edge and the front edge. For this purpose, the transport slides can be moved towards each other in the infeed area in such a way that the packages can be clamped between the transport slides or the carriers arranged on them.

The transport slides can be guided on the transport rail. Although the movement of the transport slides along the transport rail is preferably electromagnetic, especially in the form of a linear motor, a magnetic guide is not completely sufficient to hold the transport slides to the transport rail. It is therefore proposed that the transport slides are arranged on the transport rail with a U-shaped, I-shaped, L-shaped, S-shaped or C-shaped receptacle. The transport slides can grip the transport rail with their holders like clamps. The transport slides are arranged crosswise to the direction of movement in a form-fit manner. This prevents the transport slides from slipping off the transport rail. This arrangement is particularly useful when the transport rail runs at an angle, e.g. from the horizontal to the vertical.

The buffer area is preferably such that the transport slides run pointing downwards, whereas in the productive area the transport slides run pointing upwards. In the buffer area, it should be prevented that the transport slides fall off the transport rail. This is achieved by the mounting, whereby the mounting can engage in circumferential grooves on both sides of the transport rail.

As already explained, a carrier is preferably arranged on a transport slide to accommodate at least two packages. The carrier is preferably arranged on the transport slide in such a way that, at right angles to the direction of movement of the transport slide, it has several receptacles side by side on which packages can be arranged. A carrier can, for example, be placed T-shaped on a transport slide. The transport slide can preferably be arranged in the middle of the carrier. The carrier can be formed to accommodate different types of packages. At least two packages, also with different cross-sections, may be arranged on one carrier.

It is also possible that at least two parallel transport rails are provided. The transport rails are preferably congruent in their course and arranged next to each other at a constant distance from each other. Transport slides are provided on each of the transport rails. Each two transport slides are synchronized and guided on the two transport rails. This means that one transport slide is provided on each transport rail, which is synchronised with another transport slide on the other transport rail. Synchronization means that the transport slides are moved as uniformly as possible along the respective transport rail. The position of the transport slides in the direction of movement on the transport rails is preferably synchronized, so that the transport slides assume the same position on their respective transport rails at all times. A carrier can be arranged between the transport slides on which the packages can be arranged. The transport slides can also be synchronised in such a way that they have different speeds, so that the carriers arranged on them no longer run at right angles to the transport direction. Here, the carriers can be arranged with an adjustable length on the transport slides so that the distance between the transport slides guiding the carrier can increase. This allows the angle of the carrier to the transport direction to be varied.

A particularly good synchronisation of the transport slides is achieved by one transport slide being controlled on a first of the transport rails as the master slide and one transport slide being guided on a second of the transport rails as the slave slide depending on the master slide. A master-slave control enables the slave slide to always be guided synchronously to the master slide. Here, the master slide preferentially determines the position of the slide on the transport rail and the slave slide follows this position directly and in real time. This enables the two transport slides to run synchronously along their respective transport rails. It is also possible to offset the slides so that the carrier is no longer perpendicular to the direction of transport. For this purpose, the carrier can be swivelled and arranged on the transport slide with a length adjustment.

According to an embodiment, it is proposed that the transport rail has an infeed area which is at least in parts at an angle to the horizontal, in particular vertically, and that the transport slides in the infeed area are formed for receiving empty pack sleeves from an infeed unit, in particular a mandrel wheel,. The infeed of the empty pack sleeves in the area of the angled transport rail makes better use of the productive area. This means that the space utilization of the packaging machine is improved compared to conventional packaging machines. The space traditionally available in the horizontal plane has so far been used for the infeed, the productive area and the outfeed. Now the infeed takes place already in the angled part of the transport rail, so that the entire horizontal part of the transport rail can be used for the productive area and the workstations provided at it. Thus it is possible to arrange more workstations in the productive area one after the other along the movement directions of the packaging than conventional.

The same applies, of course, to the outfeed area. In the outfeed area, the transport rail can also run at an angle to the horizontal, especially vertical, at least in parts. In the outfeed area, the transport slides or the carriers arranged on them for depositing filled packages are formed on a discharge unit.

A particularly flexible application of the packaging machine is when different types of transport slides can be arranged on the transport rail. It can also make sense to at least partially uncouple the transport slide from the transport rail in order to repair or clean it if necessary without significantly impairing the operation of the transport rail or the packaging machine. For this reason, it is also proposed that the transport rail should have at least one decoupling area. An uncoupling area can be characterised by the fact that the transport rail can be swiveled there, in particular transversely to the direction of movement of the transport slides.

Transport slides can be uncoupled from the transport rail by the swiveling. This decoupling can take place selectively. Decoupled transport slides must also be recoupled so that the transport rail preferably has at least one coupling area, whereby the transport rail can also be swiveled in the coupling area. The swivel plane of the transport rail can be the same in the decoupling area and in the coupling area.

The transport rail can be swiveled so that it is swiveled onto a reserve rail and the transport slides are guided electromotorically from the transport rail to the reserve rail. After uncoupling, the transport rail can swivel back again to ensure transport of further transport slides along the transport rail. The same can be done in the coupling area in which the transport rail is swiveled onto the reserve rail in order to couple new transport slides and then swivel it back again.

According to an embodiment, it is proposed that the transport rail is guided in a sterilisation unit in the filling area. The sterilisation unit preferably surrounds the transport slides. The sterilisation unit is used for aseptic guidance of the transport slides and/or packs as well as carriers in the filling area. The sterilisation unit sterilises the transport slides and the packs and, if necessary, the carriers before they are filled with the product. Sterilization is preferably performed with H₂O₂. The transport channel of the sterilization unit, in which the transport slides and, if necessary, packs and carriers are guided, should have as small a cross-section as possible and radially enclose the transport slides, carriers and/or packages. Since the transport slides are guided along a transport rail and no transport chain is used, the guide cross-section of the sterilization unit can be kept small.

According to an embodiment, it is proposed that the sterilisation unit circumferences the transport slides radially. This means that the sterilisation unit encloses the transport slides around the direction of movement. In particular, the sterilization unit has a housing around the transport slides. Along the direction of movement of the transport slides, the sterilisation unit has at least one inlet opening and one outlet opening through which the transport slides and their packs are fed in and out. During transport through the sterilization unit, transport slides and/or carriers and packings are enclosed by the housing and sterilization can take place.

A particularly small cross-section of the housing is achieved by the fact that the housing is arranged in particular in a gap between the transport rail and the transport slide. Since the transport slides can be magnetically guided, a gap is formed between the transport rail and the transport slide. If the housing is arranged in this gap, only the transport slide, the carrier, if any, and the packs need to be sterilized.

The movement of the transport slides along the transport rail leads to a movement of the ambient air also along the direction of movement. If the sterilisation unit is formed in such a way that first sterilising agent, in particular H₂O₂, is added, this sterilising agent is carried along into the sterilisation unit by the draught produced. Steam can then be added to thermally sterilize the transport slides and/or packs. The steam is also entrained along the direction of movement by the draft of air generated by the movement. The supply of steam for hot sterilisation, in particular for steam sterilisation, can take place in particular during or after the supply of the product, in particular at or after the filling device.

In order to safely discharge the sterilising agent, in particular to prevent sterilising agent from remaining in the packaging together with the product, it is also proposed that at least one exhaust opening be provided between the supply of sterilising agent and the supply of steam in the sterilisation unit. The sterilising agent entrained by the draught can be removed via the exhaust air opening. The resulting air pressure prevents non-sterile air from being drawn into the sterilization unit through the exhaust opening.

A particularly good cleaning of the workstations along the productive area, in particular the filling device, can be carried out by means of transport slides set up for this purpose. For example, it is possible that cleaning slides with cleaning units can be coupled to the transport rail via coupling and uncoupling. The cleaning units on the cleaning slides can be arranged as carriers on the transport slides. For example, the cleaning unit may have brushes pointing away from the transport rail, which perform mechanical cleaning at the workstations when the transport slide is transported along the production area. Cleaning units may also be provided, preferably with a battery-operated pump and a reservoir of sterilising agent. If such a transport slide with a cleaning unit is guided along the productive area, the pump can be activated and the cleaning agent, in particular the sterilising agent, can be sprayed from the reservoir into the working area.

It is also possible to clean and sterilize the transport means or carriers in the buffer area. This can be done along the transport rail or after uncoupling to a reserve rail.

Due to the buffer area, it is possible to arrange more transport slides on the transport rail than are required for the current production. This makes it possible to discharge a defective transport slide without interrupting the production process. Since an excess number of transport slides can be provided in the buffer area, it is possible to remove individual transport slides in the meantime in order to clean them, repair them or take other measures. The remaining transport slides can be guided along the transport rail in the usual cycle over the infeed area, the productive area and the outfeed area.

The productive area has in particular the following workstations alternatively or cumulatively. Initially, a sterilisation station may be provided in which sterilising agent is applied to the slides and/or carriers and/or packs, in particular sprayed on. A further workstation may include the action of the sterilising agent. Another workstation can include drying of the transport slide, the carrier and/or the packs. Further workstations can contain filling units, whereby the filling units are preferably arranged in duplicate one after the other along the transport direction so that at least two packs can be filled at a time or in one cycle. The filling devices can realise different filling speeds and can also contain different product mixtures, for example. It is also possible for a first filling device to feed inert gas, whereas a second filling device feeds only the product to be filled. Another workstation may include the application of steam and/or folding of a pack gable. A further workstation may include sealing of the gable, in particular with ultrasound. A further workstation can include, for example, the application of applications such as pourers. The workstations that follow after sealing can also be arranged in an already discharge area in an angular area of the transport rail. Another workstation can be an ejector. This description of the productive area is purely exemplary.

Another aspect is a method according to claim 29.

If before or after the transport direction of the packs and/or transport direction of the transport slide is mentioned, these two terms are equivalent. Since a pack is always moved along the transport direction of the transport slide, whether it is placed directly on the transport slide or transported via a carrier arranged on the transport slide, this is irrelevant.

In the following, the subject matter is explained in more detail using a drawing showing embodiments. In the drawings show:

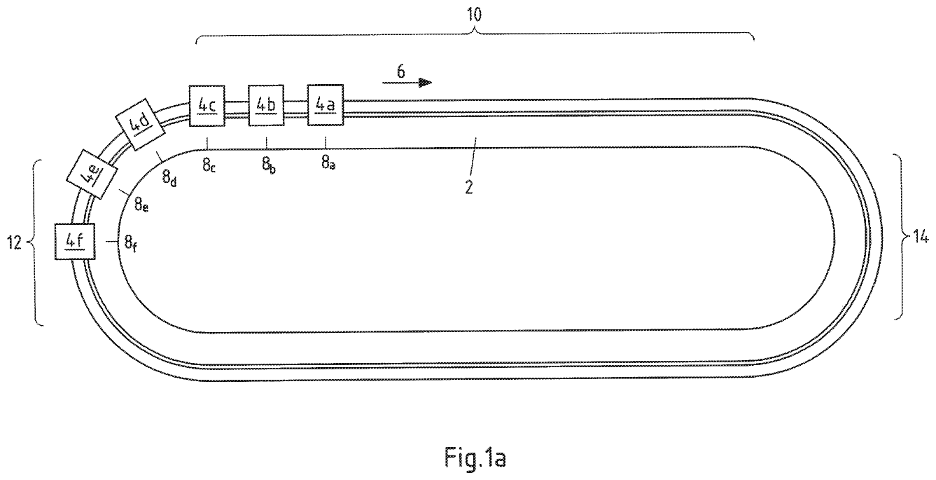

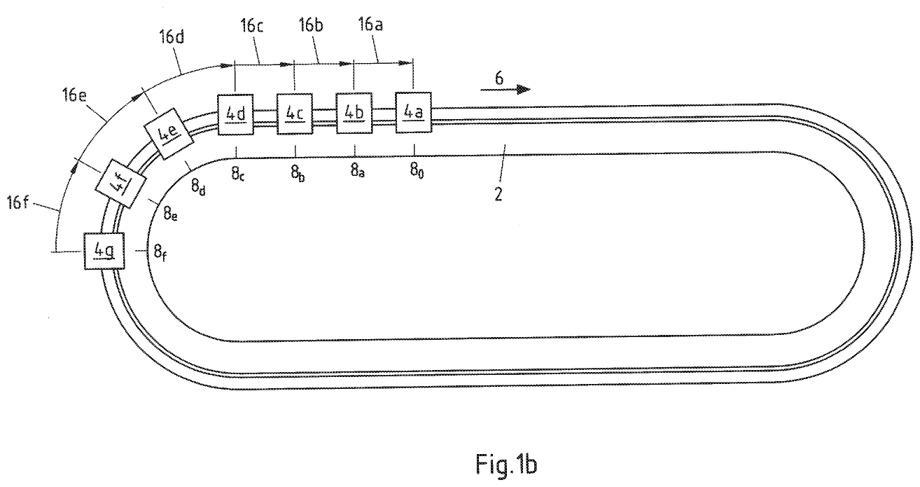

FIG. 1a-e the transport of transport slides along a transport rail with different indices;

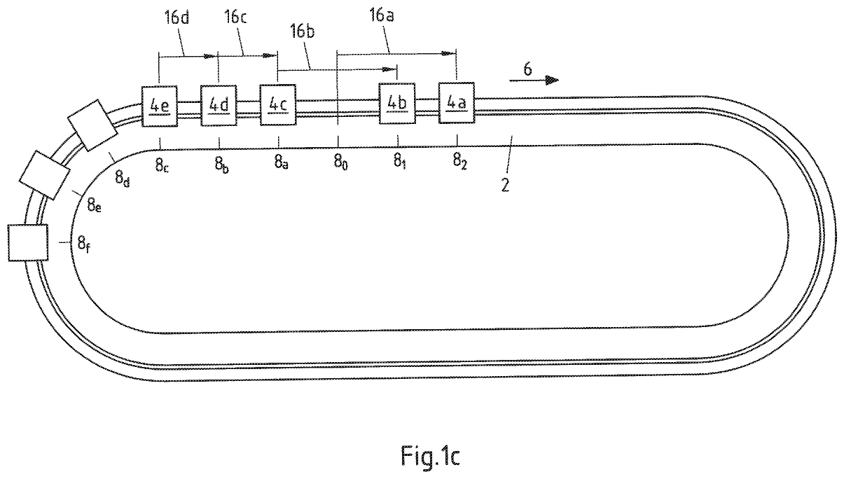

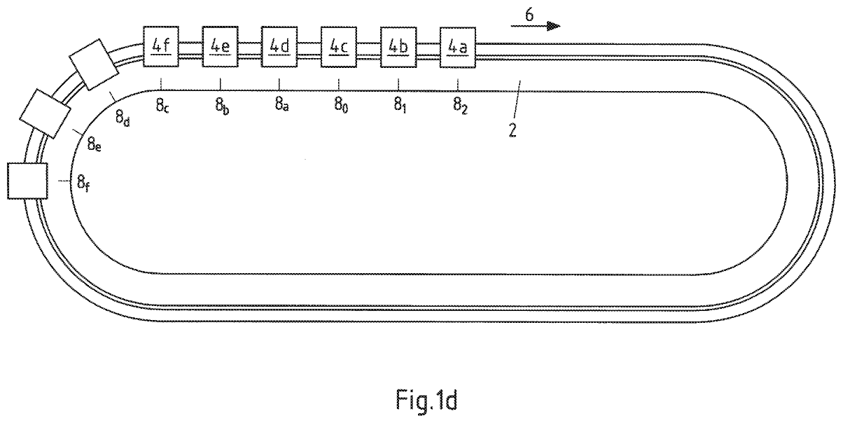

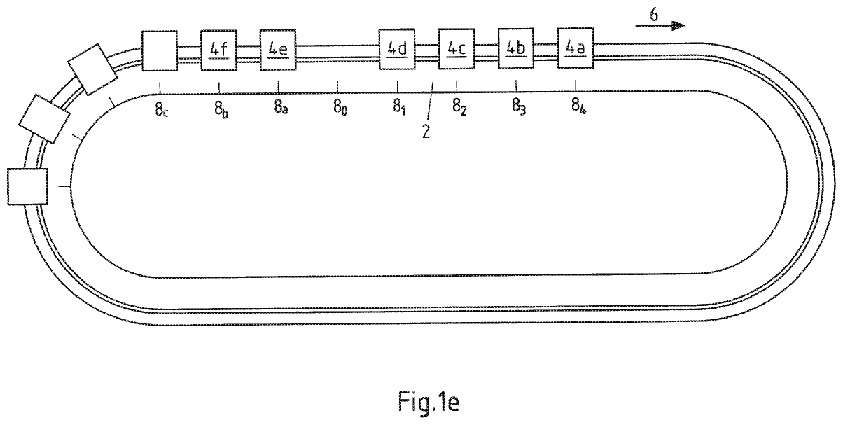

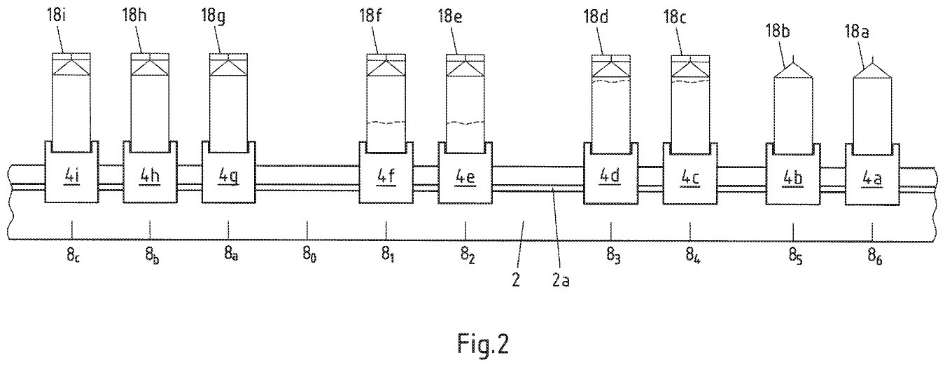

FIG. 2 the transport of transport slides along a transport rail according to an embodiment;

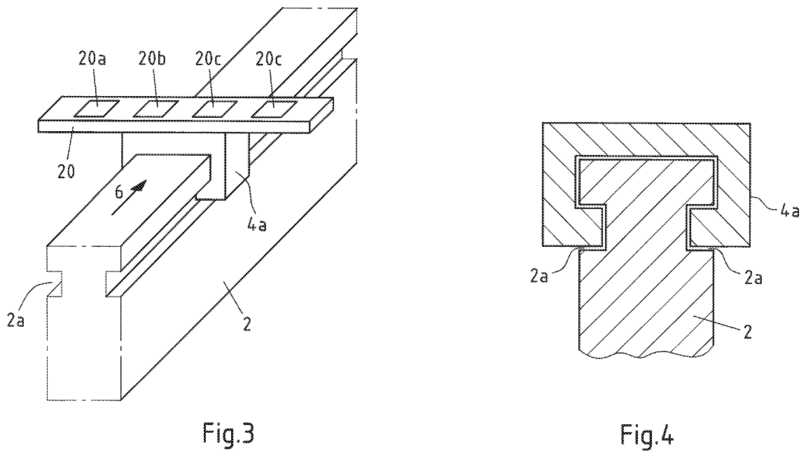

FIG. 3 a transport slide with a carrier according to an embodiment;

FIG. 4 a cross-section of a transport slide with a transport rail and a guide according to an embodiment;

FIG. 5 two parallel transport rails, each with synchronised transport slides according to an embodiment;

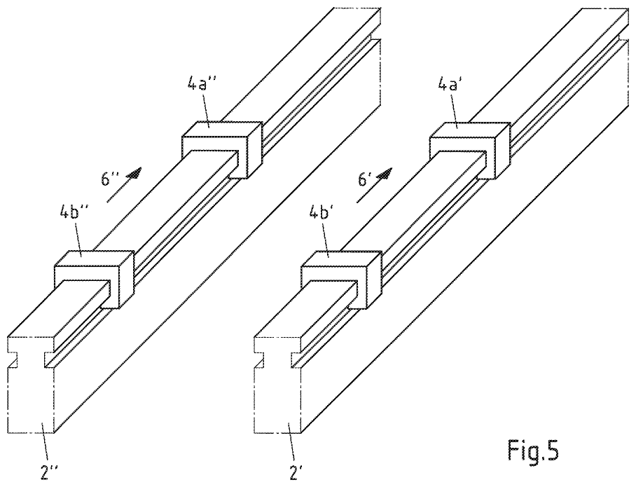

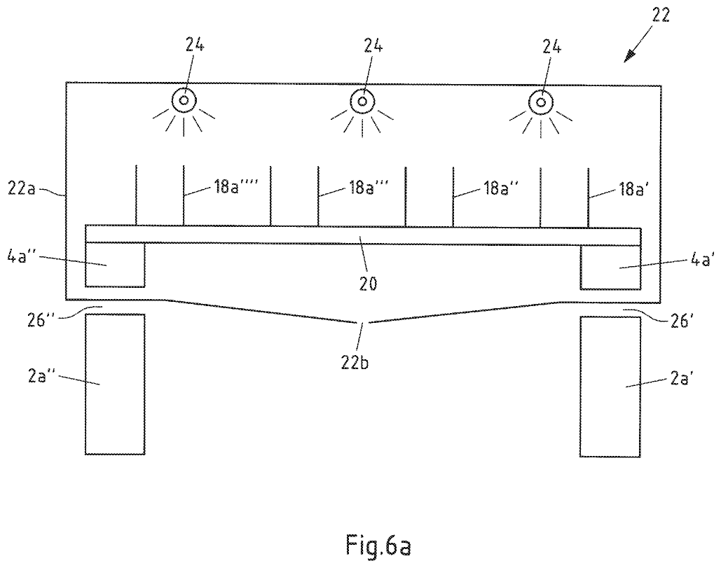

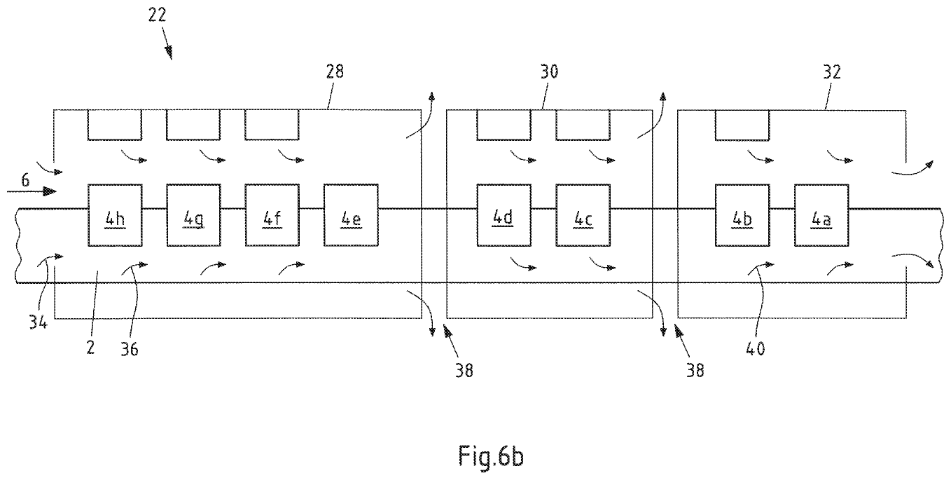

FIG. 6a a cross-section of a sterilisation unit with cleaning and sterile air supply;

FIG. 6b a view of a sterilisation unit with supply and discharge of sterilising agents and steam according to an embodiment;

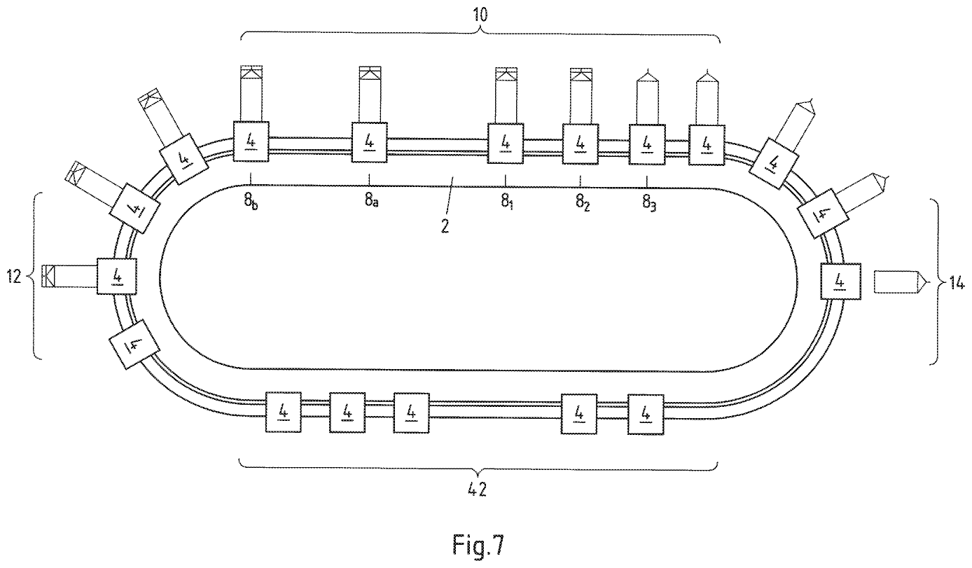

FIG. 7 a closed ring of a transport rail according to an embodiment;

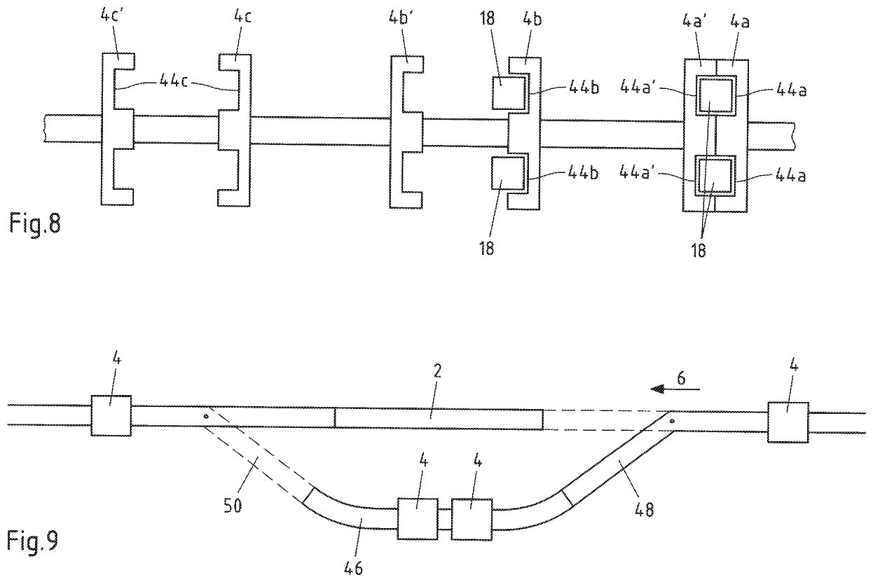

FIG. 8 a guidance of packings with carriers according to an embodiment;

FIG. 9 a transport rail with a reserve rail and a possibility of decoupling according to an embodiment.

FIG. 1a shows a transport rail 2 with transport slides 4a-f guided on it in a schematic view. The transport slides 4a-f are moved on the transport rail 2 by electromotorically in the direction of movement 6. Each individual transport slide 4a-f is preferably controlled individually, so that its position as well as its feed movement is defined along the transport rail 2. The transport slides 4a-f can take defined positions 8a-f along the transport rail 2. The defined positions 8a-f preferably correspond to workstations that are not displayed, where packs that are transported on the transport slide 4a-f are processed. The transport rail 2 can, for example, be divided into a productive area 10, an infeed area 12 and an outfeed area 14. In the infeed area 12, unfolded packages are placed on the transport slide 4a-f and pre-cleaned if necessary. In production area 10, the packages are fed to a sterilisation unit together with the transport slide and/or carrier, sterilised and then filled with the product. The filled packages are first closed and then fed out of the productive area 10. The closed, filled packages are ejected from the transport slides 4a-f or the carriers arranged on them in the outfeed area and are fed for further processing.

The transport rail 2 with the transport slides 4a-f preferably forms a linear motor, whereby the transport rail 2 preferably has a multitude of coils arranged side by side along the direction of movement 6, so that a magnetic field can be controlled along the transport rail 2. The transport slides 4a-f are preferably arranged slidingly on the transport rail 2 and are magnetically driven by the transport rail 2 or the coils arranged therein and moved in the direction of movement 6.

The transport of the transport slides 4a-f along the direction of movement 6, which can also be understood as the feed direction, is preferably cycled. This means that a feed from one position 8a-f to the next position 8a-f takes place in one cycle and that a dwell time is then maintained in which the transport slides 4a-f dwell on their respective position 8a-f. The stroke including the dwell time can be understood as a cycle time.

The transport stroke along the movement direction 6 corresponds to the distance between two positions 8a-f adjacent to each other along the movement direction 6. In contrast to a conveyor belt or a transport chain, the transport stroke can be variable between two positions 8a-f, since each individual transport slide 4a-f can be controlled individually. This is advantageous in that the distances between the positions can be adapted to the space requirements of the respective workstation, and not the other way round as is the case with conventional workstations.

As an example, the transport slide 4c is first moved in one cycle from position 8c to position 8b during the feed time and then the transport slide 4c remains at position 8b for a dwell time. Then the next cycle takes place in which the transport slide 4c is moved to position 8a and then remains there for a dwell time.

In particular, the cycle time for each individual transport slide 4a-f on transport rail 2 is the same, i.e. the sum of the feed time and dwell time is the same. Thus the transport slides 4a-f are moved in a clocked movement along the transport rail 2 through the infeed area 12, the productive area 10 and the outfeed area 14.

During the dwell time a work step is carried out at the workstations assigned to the respective positions 8a-f on the packages arranged on the transport slide 4a-f.

By using the transport rail 2 it is possible to individually design the transport stroke (also called feed path or feed section) as well as the dwell time, also called hold time. This means, for example, that a transport slide 4a-f in one cycle can have a standard transport stroke and a standard dwell time, but it is also possible that, for example, in the case of a double transport stroke compared to the standard transport stroke, the dwell time can be at a position 8a-f until the end of the second subsequent cycle, as described below. This increased transport speed in the transport time, which leads to the increased transport stroke, can be understood as a synonym for an index that has been changed from a standard hub during a standard time with a standard dwell time. A modified index can also be understood as meaning that for the movement from one position 8a-f to the next position 8a-f, including the dwell time spent there, more than one standard clock, in particular 2 or more standard clocks, are used, as will be described below.

FIG. 1a shows the transport rail 2 of the filling device at a time T0.

Starting from this time T0, at the beginning of a cycle, the transport slides 4a-f are first moved by the transport stroke 16 from a position 8a-f to the next position 8a-f. The transport slides 4a-f are then moved by the transport stroke 16. This means that the transport slide 4a is transported by the transport stroke 16a, the transport slide 4 by the transport stroke 16b and so on. After the feed time, which can be set individually for each feed between two adjacent positions 8a-f, there is a dwell time which can also be set, but should be such that the sum of transport time and dwell time corresponds exactly to the time of one cycle.

During the dwell time, the transport slides 4a-f remain at positions 8a-f and the workstations can process the packages arranged on the transport slides 4a-f. The sum of the feed time and the dwell time preferably corresponds to one cycle. After one cycle has elapsed, the movement continues as shown in FIG. 1b.

FIG. 1b shows that the transport slide 4f has been moved to position 8e, whereupon a new transport slide 4g is fed from a buffer area of the transport rail 2 and remains in position 8f. Here, an unfolded pack sleeve can be applied to the 4g transport slide or a carrier arranged on it. It is also possible for several unfolded packages to be placed parallel to each other on a carrier arranged on the 4a-g transport slide.

FIG. 1b also shows that the transport slide 4a has been moved from position 8a to position 8₀ adjacent in the direction of movement 6.

FIG. 1c shows the movement of the transport slides 4a, b with a double index. Starting from FIG. 1b, the transport slide 4a was moved at the beginning of the cycle by the transport stroke 16a, the transport stroke 16a being such that the transport slide 4a was moved from position 8₀ to position 8₂. Starting from FIG. 1b, the transport slide 4b was moved by the transport stroke 16b starting from position 8a to position 8₁.It can be seen that the transport strokes 16a, 16b are increased compared to the transport strokes 16c-f. Due to the increased transport strokes 16a, 16b, position 8₀ is unoccupied at the end of the transport time. Thus it is now possible in the next cycle, as shown in FIG. 1d, to move the transport slides 4c-f again along the direction of movement 16 with a standard transport stroke to the positions 80-c. The transport slides 4c-f can then be moved to the 8_{0-c} with a standard transport stroke. Meanwhile, the transport slides 4a, b may remain at positions 81, 82. This extended dwell time can be used to continue the filling process on the packages arranged on the transport slides 4a, b. The filling process can also be continued on the packaging. A filling device can be provided both at position 81 and at position 82. Due to the longer dwell time, it is possible to fill the product at lower flow speeds, which increases the production quality.

As can be seen from the FIGS. 1c-d, the time for the transport slides 4a,b from the beginning of the movement from position 8a,b to positions 81,2 to the end of the work step, here the filling process, is longer, preferably twice as long, as it is for the movement in one cycle for example from position 8c to position 8b or from position 8b to position 8a. This can be understood as a longer or double index.

At the end of the second cycle after the beginning of the movement of the transport slide 4a, b from positions 8_{0,a} to positions 8_{1,2}, the work step at the workstations at positions 8_{1, 2} is completed. Then the transport slides 4a-f are moved further according to FIG. 1e. In this case, the transport slides 4a, b are again moved at an increased speed and a greater transport stroke from position 8₂ to position 8₄ or from position 8₁ to position 8₃. At the same time, the transport slides 4c are moved from position 8₀ and 4d from position 8ₐ to position 8₂ and 8₁ respectively. These two increased transport strokes in the transport time are caused by an increased speed. This can also be understood as an increased index. Meanwhile the transport slides 4e were moved from position 8b to position 8a and 4f from position 8c to position 8b.

In the next cycle, the transport slides 4a, b can then be moved one position at a time in the normal cycle, whereby the transport slides 4c and d remain at positions 8_{1,2} in this cycle at the same time and the transport slide 4e is moved to position 8₀ and the transport slide 4f to position 8a. During this entire cycle, the workstation at position 8₁, 8₂ can process the packages arranged there and thus has an increased processing time.

FIG. 2 shows a transport rail 2 with transport slides 4a-i. It can be seen that the transport rail 2 has a guide 2a, which for example is designed as a continuous groove. In contrast to FIG. 1a-d, in the productive area along the transport rail 2 there are two filling devices next to each other in double design at positions 8_{1,2} and 8_{3,4}. At the beginning of a first cycle, the transport slides 4e, f are moved from positions 8_{a,0} to positions 8_{1,2}. At the same time at the beginning of the cycle the transport slide 4c is moved from position 8₂ to position 8₄ and the transport slide 4d from position 8₁ to position 8₃. Then, preferably in the same cycle, a filling process is carried out on the 18c-f pack sleeves, which are still open at the top. At positions 8_{1, 2} prefilling takes place and at positions 8_{3, 4} filling takes place. The production quality can be increased by the double filling process. The accuracy of the filling quantity can also be increased. In the next cycle, only the transport slides 4g-i and the transport slides 4a-b are moved by one position each, whereas the transport slides 4c-f remain in their previous positions and the filling process can be continued. This filling process lasts until the end of the second cycle and only at the beginning of the third cycle does the transport slide 4c-f also feed, whereby the transport slide 4c-d is moved from positions 8_{4, 3} and 8_{6,5} respectively and the transport slide 4e, f is moved from positions 8_{2, 1} and 8_{4, 3} respectively. This double stroke is also carried out for the transport slides 4g, h, which are moved from positions 8a, 0 respectively to positions 8_{1, 2} and where the filling process can begin.

No workstation is provided at position 8₀ and at position 8₅, i.e. the position which only every second pack 18a-i moves to due to the enlarged index, so that no processing takes place there. This means that an empty position can exist between two processing positions in the area of the changed index. Position 8₅ can also be without further processing of the package 18b, and the gable of the packaging can be closed, for example, at position 8₆ on package 18a.

As already explained in FIG. 2, the transport rail 2 has a continuous groove 2a, which is shown schematically in FIG. 3. A C-shaped profile of a transport slide 4a can be inserted in this groove. A carrier 20 can be arranged on the transport slide 4a. The carrier 20 may have receptacles 20a-d for holding 18a-i pack sleeves. The receptacles 20a-d may preferably be corresponding to the base cross-section of the packs 18a-i, but may also, for example, clamp the packing or similar.

The slide 4a is guided through the guide 2a on the transport rail 2 and is there positively secured against being detached transversely to the direction of movement 6.

This mechanical securing is shown again in FIG. 4. It can be seen that the transport slide 4a has a C-shaped receptacle which is guided in the groove 2a of the transport rail 2. The guidance of the transport slide 4a on the transport rail 2 shown in FIG. 4 is particularly advantageous if the transport rail 2 specifies a direction of movement of the transport slide 4a which is not only horizontal but vertical if necessary. Especially if the transport slides 4a are guided on the transport rail 2 pointing in the direction of the ground. Then the transport slides 4a cannot fall off the transport rail 2.

FIG. 5 shows another example in which two transport rails 2′, 2″ are arranged parallel to each other. Transport slides 4a′, 4b′ or 4a″, 4b″ can be arranged on each of the transport rails 2′, 2′. In each case two transport slides 4a′, 4a″ and 4b″, 4b″ respectively are synchronised with one another, so that their movement along the movement direction 6′, 6″ along the guide rails 2′, 2″ is synchronised. A suitable control ensures that in particular the acceleration profile and the positioning at one of the positions 8a-f between two of the transport slides 4a′, 4a″; 4b′, 4b″ is almost identical. It is preferred if one transport slide 4a′, 4b′ on one transport rail 2′ acts as master and the other transport slide 4a″, 4b″ on the other transport rail 2″ as slave follows the master directly.

Between the transport slides 4a, 4a″ and 4b and 4b″ there can be one carrier 20 each, but this is not shown for the sake of clarity.

Such a representation, with a carrier 20 arranged between two transport slides 4a′, 4a″, is shown in FIG. 6a. FIG. 6a shows schematically a cross section through a sterilization unit. You can see that the sterilization unit 22 has a housing 22a. The housing 22a encloses the transport slides 4a′, 4a″ as well as the carrier 20 and the packing sleeves 18a′-a″″ arranged on it circumferentially. Inside housing 22a, for example, there may be 24 sterilisation or steam applicators, which, for example, spray sterilising agents and/or steam onto the packing sleeves 18a′, 18a″″ or otherwise apply them.

The bottom of the housing 22 is preferably tapered, with preferably a drain bead 22b, in which the unused sterilising agent or the water of the water vapour can collect and drain off or be sucked off.

It can also be seen that the housing 22a is guided in a gap 26′, 26″ between a respective transport slide 4a′, 4a″ and a respective transport rail 2a′, 2a″. This means that the volume inside the housing 22a is as small as possible, so that the consumption of sterilising agents is reduced.

As the transport slides 4a′, 4a″ are preferably guided electromagnetically through the transport rail 2a′, 2a″ in the manner of a linear motor, an air gap can be provided, since the magnetic forces can also act beyond the air gap. This means that the housing 22a can be arranged closed all around the carrier 20 and the packagingES 18 arranged on it.

During transport of the transport slides 4 through the sterilisation unit 20, the transport slides 4 move in the direction of movement 6 as shown in FIG. 6b. FIG. 6b shows a schematic view of a sterilisation unit 22 with a steriliser 28, a filling unit 30 and a sealing unit 32.

Units 28-32 can be part of productive area 10. The transport slides 4a-h together with packages 18 are moved along the transport rail 2 through the areas 28-32. The movement in movement direction 6 causes ambient air to be carried along, as shown by the arrows 34. Applied sterilant is carried along in the sterilizer 28 in the direction of arrows 36 by the air stream. Vent slots 38 may be provided between the sterilizer 28 and the filling unit 30 to remove any excess sterilant.

The filling unit can be filled with inert gas (e.g. nitrogen) and/or steam. In addition, the product is placed in the package 18. A ventilation slot 38 can again be provided between the filling unit 30 and the clamping unit 32, so that excess steam or excess sterilising agent or excess nitrogen can also be removed here.

In the sealing unit 32, for example, sealing under steam can be carried out. This applied steam is also carried by the air flow in the direction of the arrows 40 and ejected at the end of the sterilization unit 22.

FIG. 7 shows the transport rail 2 as a closed ring. The transport rail 2 has an infeed area 12, a productive area 10, as well as an outfeed area 14 and a buffer area 42. The transport slides are moved in a cycled manner in the infeed area 12, the productive area 10 and the outfeed area 14 as described. In buffer area 42, the transport slides 4 can be sterilized or cleaned. The productive area 10 comprises at least a part of the transport rail 2 in which the transport slides 4 are moved horizontally. Along the infeed area 12 as well as the outfeed area 14, the transport rail can be shaped in such a way that the transport slides 4 are moved at an angle, especially in a vertical direction, at least in parts. Preferably the transport rail 2 in buffer area 42 runs parallel to the transport rail 2 in productive area and the transport slides 4 are arranged pointing downwards on the transport rail 2. The transport slides 4 can be moved untimed in the buffer area. It should only be ensured that at the beginning of each cycle one transport slide 4 is available for transport into the infeed area 12.

In the infeed area 12, for example, an unfolded package 18 is first placed on a transport slide 4 in a cycled fashion, and then the unfolded package sleeve 18 is cleaned in the next cycle. In the next cycle, the transport slide 4 is moved to production area 10. There the transport slides 4 are moved according to the description of FIG. 1a-d with single and double index, for example, and the transport slides 4 as well as the packages 18 are sterilised, filled and sealed there. The filled, sealed packages 18 are then moved to the outfeed area 14 and ejected there.

In buffer area 42, the empty transport slides 4 arrive and can be cleaned there and, if necessary, temporarily stored for a new round trip.

A carrier 20 can hold the packages, for example, by receptacles. It is also possible that corresponding carriers are arranged on two transport slides 4 arranged one behind the other, as shown in FIG. 8. FIG. 8 shows a top view of a transport rail 2 with several transport slides 4a-c, 4a′-c′ or correspondingly shaped carriers. The illustration in FIG. 8 corresponds to three cycles during the processing of the packages. First, the transport slides 4c, 4c′ are moved to the infeed area 12 spaced apart from each other. The distance between a leading edge 44′ and a trailing edge 44c of two adjacent transport slides 4c, 4c′ is so large that packages 18 can be inserted. In the next cycle, the packages 18 are inserted between the transport slides 4b, 4b″ and arranged, for example, so that they are positioned at a recess at the rear edge 44b of the slide 4b. In the next cycle, the packages 18 are clamped between the transport slides 4a. 4a′ such that the distance between the transport slides 4a, 4a′ is such that the package is clamped between the respective trailing edge 44a and the leading edge 44a′. This clamping is possible by individually controlling the position of each of the slides 4a, 4a′. The procedure according to FIG. 8 can also be carried out in a single cycle during infeed.

In the buffer area it is possible to feed in transport slide 4 from transport rail 2 to a reserve rail 46. For this purpose, an outfeed 48 and an infeed 50 are provided on the transport rail 2. The outfeed 48 of the transport rail 2 can be swivelled transversely to the direction of movement 6, so that it can be coupled to the reserve rail 46. Transport slides 4, which are moved in the direction of movement 6, are moved onto the reserve rail 46 via the outfeed 48. There, for example, they can be removed from the reserve rail 46, repaired and reattached without affecting the running operation along the transport rail 2. The transport slide 4 can be moved back again from the reserve rail 46 to the transport rail 2 via the infeed 50, which can also be swivelled transversely to the direction of movement 6.

With the help of the present packaging device it is possible to set the working time individually at different workstations.

1. A packaging machine, in particular filling device, with
at least one transport rail, and
at least two transport slides movable along the transport rail and arranged on the transport rail, wherein
the transport slides are arranged for transporting at least one package and are moved at least in sections in a cycled manner along a productive area of the transport rail, wherein a cycle is formed by a feed time and a dwell time and wherein
the transport rail and the transport slides are electromotively coupled to one another in such a way that the transport slides are moved along a productive area with two indices which are different from one another, wherein the index is formed by the ratio between a dwell time at a work station and a feed time between two workstations,
characterized in that
a carrier is arranged at the transpot slide, which carries a bottom of a package.

2. The packaging machine according to claim 1,
characterized in that
the transport slides are moved in the productive area in the region of a filling device, in particular a bottling device, with a different, in particular larger index than outside the filling device.

3. The packaging machine according to claim 1,
characterized in that
the index is determined by the hold time at a workstation and a feed time between two workstations.

4. The packaging machine according to claim 1,
characterized in that
at least N transport slides with an N-fold index are respectively moved in the filling device, where N is greater than 1, in particular in that the transport slides are moved with an index greater than 1.

5. The packaging machine according to claim 1,
characterized in that
at least two transport slides are moved in the filling device at a higher, preferably at least double, feed speed, and/or
at least two transport slides arc moved with a higher, preferably at least double, feed stroke within the feed time.

6. The packaging machine according to claim 1,
characterized in that
the feed time between two workstations in the productive area is constant.

7. The packaging machine according to claim 1,
characterized in that
the hold time of at least two transport slides in the filling device is greater than or less than the hold time of the packages outside the filling device, in particular at least twice the hold time of the packages outside the filling device.

8. The packaging machine according to claim 1.
characterized in that
the transport stroke of the transport slides in the productive area between two workstations in each case is different in one cycle.

9. The packaging machine according to claim 1,
characterized in that
the transport slides are moved in the productive area between two workstations each with different acceleration profiles.

10. The packaging machine according to claim 1,
characterized in that
the transport rail has an infeed area, a productive area, an outfeed area and a buffer area, the transport direction of the transport slides extending in at least one first area at an angle to at least one second area, in particular at an angle between 30° and 60°.

11. The packaging machine according to claim 1,
characterized in that
the transport rail and the transport slides are formed as a linear motor.

12. (canceled)

13. (canceled)

14. The packaging machine according to claim 1,
characterized in that
the transport rail has at least one leg along a transport device, in particular in that the transport device forms a closed ring with at least one leg in the form of the transport rail.

15. The packaging machine according to claim 1,
characterized in that
the transport rail forms at least one leg partially along the productive area of the legs guided at least partially in the filling device of the packaging machine and/or in that the transport rail forms a leg at least partially along a buffer area, in particular in that the legs lie opposite one another.

16. The packaging machine according to claim 1,
characterized in that
the transport slides are arranged on the transport rail with a U-shaped or C-shaped receptacle, in particular in that the transport slides are arranged at an angle to their direction of movement in a form-fitting manner on the transport rail.

17. (canceled)

18. The packaging machine according to claim 1,
characterized in that
two transport rails running parallel to one another are provided with respective transport slides arranged thereon, wherein respective two transport slides being guided synchronously on the two transport rails.

19. The packaging machine according to claim 1,
characterized in that
a transport slide is controlled on a first of the transport rails as a master slide and a transport slide is guided on a second of the transport rails as a slave slide as a function of the master slide.

20. The packaging machine according to claim 1,
characterized in that
the transport rail has an infeed area extending at least in parts vertically, and in that the transport slides are formed in the infeed area by a feed unit, in particular by a mandrel wheel, for receiving empty pack sleeves.

21. The packaging machine according to claim 1,
characterized in that
the transport rail has a outfeed area extending at least in parts at an angle to the horizontal, and in that the transport slides are formed in the outfeed region for depositing filled packages on a discharge unit.

22. The packaging machine according to claim 1,
characterized in that
the transport rail has at least one coupling-out area, the transport rail being swivable in the coupling-out area and/or in that the transport rail has at least one coupling-in area, the transport rail being swivable in the coupling-in area.

23. The packaging machine according to claim 1,
characterized in that
the decoupling area is arranged in the buffer area.

24. The packaging machine according to claim 1,
characterized in that
the transport rail is guided in the filling area in a sterilisation unit, the sterilisation unit enclosing the transport slides in a circumferential manner.

25. The packaging machine according to claim 1,
characterized in that
the sterilisation unit surrounds the transport slides radially circumferentially, in particular in that the sterilisation unit forms a housing around the transport slides.

26. (canceled)

27. (canceled)

28. The packaging machine according to claim 1,
characterized in that
at least one transport slide is formed as a carrier for at least one cleaning unit, the cleaning unit being guided through the transport slide along the productive region.

29. A method of operating a packaging machine, in particular a filling device, in which
at least two transport slides arc moved along a transport rail, and
packages are moved in a cycled container stream along a productive area of the transport rail by the transport slides, wherein a cycle is formed by a feed time and a dwell time and wherein
transport rail and the transport slides are electromotively coupled to one another in such a way that the transport slides are moved along a productive area with two indices which are different from one another
characterized in that
that packages carried with their bottoms by carriers arranged at the transport slides.

30. The method according to claim 29,
characterized in that
the transport slides are moved with an index and/or a speed as a function of an operating mode of the packaging machine and/or the transport slides are positioned as a function of an operating mode of the packaging machine.
